(19) United States
(12) Patent Application Publication
(10) Pub. No.: US 2020/0130072 A1
(43) Pub. Date: Apr. 30, 2020

(54) CUTTING INSERT, CUTTING TOOL, AND METHOD FOR MANUFACTURING MACHINED PRODUCT

(71) Applicant: KYOCERA Corporation, Kyoto-shi (JP)

(72) Inventor: Hirohisa ISHI, Moriyama-city (JP)

(73) Assignee: KYOCERA Corporation, Kyoto-shi (JP)

(21) Appl. No.: 16/666,649

(22) Filed: Oct. 29, 2019

(30) Foreign Application Priority Data
Oct. 31, 2018 (JP) 2018-205561

(51) Int. Cl. B23C 5/20; B23C 5/06

(52) U.S. Cl. CPC B23C 5/207; B23C 5/06

(57) ABSTRACT

A cutting insert of one aspect includes a first face, a second face, and a third face. The first face includes a first side, a second side, and a first corner. The first face includes a land face connected to the third face. The land face includes a first land face connected to the first corner, a second land face, and a third land face. The first land face includes a first region connected to the second land face and a second region connected to the third land face. When the first face is viewed from the front, a second width of the second region is larger than a first width of the first region in a front view of the first face.

### TECHNICAL FIELD

The present disclosure relates to a cutting insert, a cutting tool used in machining, and a method for manufacturing a machined product. The cutting tool includes, for example, a rotating tool, a turning tool, and the like. The rotating tool includes, for example, a milling tool, an end mill, and the like.

### BACKGROUND

As a cutting insert used in machining a workpiece made of metal or the like, a cutting insert disclosed in JP 2009-131943 A (Patent Document 1) is known. The cutting insert disclosed in Patent Document 1 includes a second chamfered face as a land face. The width of the second chamfered face is greatest on a bisecting line of a corner portion.

When the cutting insert described in Patent Document 1 is used in machining, of the corner portion thereof, a portion closer to one of adjacent sides tends to have a larger cutting edge angle than a portion positioned on the bisecting line. Therefore, there is a demand to increase the durability of a land face on the portion closer to one of the sides adjacent to the corner portion than the portion positioned on the bisecting line of the corner portion.

### SUMMARY OF INVENTION

A cutting insert according to a non-limiting aspect of the present disclosure includes a first face, a second face, a third face, a virtual central axis, and a virtual reference face. The first face includes a first side, a second side, and a first corner positioned between the first side and the second side. The second face is positioned on an opposite side to the first face. The third face is positioned between the first face and the second face. The central axis is a virtual straight line that passes through a center of the first face and a center of the second face. The reference plane is a virtual plane that is positioned between the first face and the second face and is orthogonal to the central axis.

The first face includes a land face that is connected to the third face and is inclined further away from the reference plane as the land face is away from the third face. The land face includes a first land face connected to the first corner, a second land face connected to the first side, and a third land face connected to the second side. The first land face includes a first region connected to the second land face, and a second region connected to the third land face. Then, a second width of the second region is larger than a first width of the first region in a front view of the first face.

### BRIEF DESCRIPTION OF DRAWINGS

FIG. 1 is a perspective view illustrating a cutting insert according to a non-limiting embodiment of the present disclosure.

FIG. 2 is an enlarged view of a region A1 illustrated in FIG. 1.

FIG. 3 is a plan view of the cutting insert illustrated in FIG. 1, as viewed from a side of a first face.

FIG. 4 is a side view of the cutting insert illustrated in FIG. 3, as viewed from a direction B1.

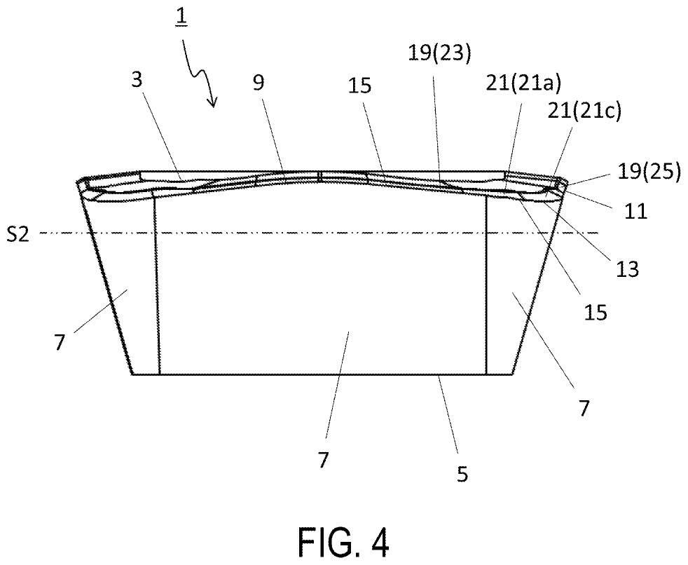

FIG. 5 is a side view of the cutting insert illustrated in FIG. 3, as viewed from a direction B2.

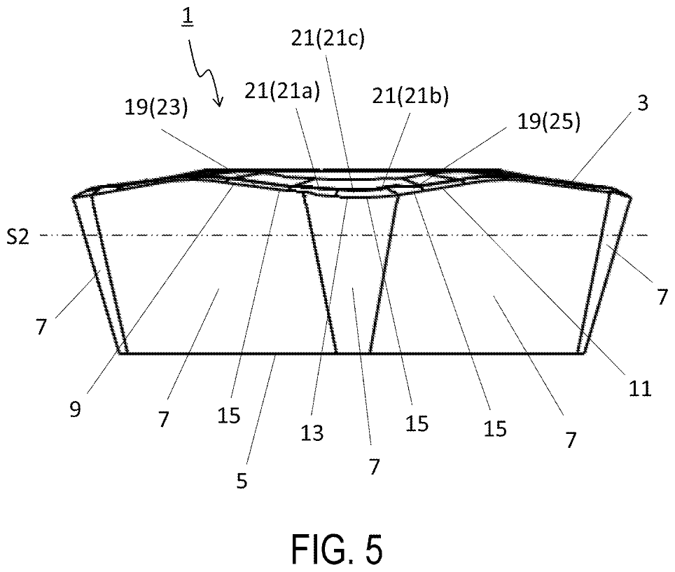

FIG. 6 is a side view of the cutting insert illustrated in FIG. 3, as viewed from a direction B3.

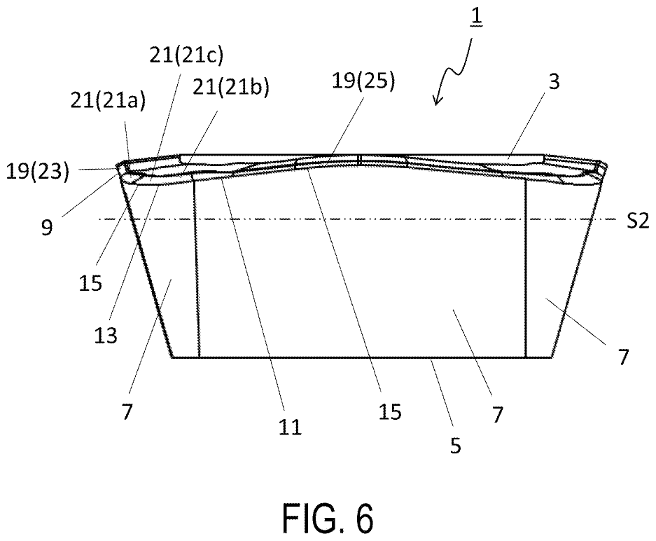

FIG. 7 is an enlarged view of a region A2 illustrated in FIG. 3.

FIG. 8 is a cross-sectional view of the cutting insert illustrated in FIG. 7, along a cross-section VIII.

FIG. 9 is a cross-sectional view of the cutting insert illustrated in FIG. 7, along a cross-section IX.

FIG. 10 is a cross-sectional view of the cutting insert illustrated in FIG. 7, along a cross-section X.

FIG. 11 is a cross-sectional view of the cutting insert illustrated in FIG. 7, along a cross-section XI.

FIG. 12 is a cross-sectional view of the cutting insert illustrated in FIG. 7, along a cross-section XII.

FIG. 13 is a perspective view illustrating a cutting tool according to a non-limiting embodiment of the present disclosure.

FIG. 14 is a side view of the cutting tool illustrated in FIG. 13.

FIG. 15 is a schematic view illustrating one step of a method for manufacturing a machined product according to a non-limiting embodiment of the present disclosure.

FIG. 16 is a schematic view illustrating one step of the method for manufacturing the machined product according to a non-limiting embodiment of the present disclosure.

FIG. 17 is a schematic view illustrating one step of the method for manufacturing the machined product according to a non-limiting embodiment of the present disclosure.

### DESCRIPTION OF EMBODIMENTS

A detailed description will be given below of a cutting insert 1 of an embodiment (hereinafter also simply referred to as the insert 1), with reference to the drawings. However, for ease of explanation, each of the drawings referenced below may be simplified and may illustrate only the main constituent members needed to describe embodiments. Accordingly, the cutting tool disclosed below may be provided with any constituent member that is not illustrated in each of the referenced drawings. Further, the dimensions of the members in the drawings do not faithfully represent the actual dimensions of the constituent members, the dimension ratios of the members, or the like.

### Insert

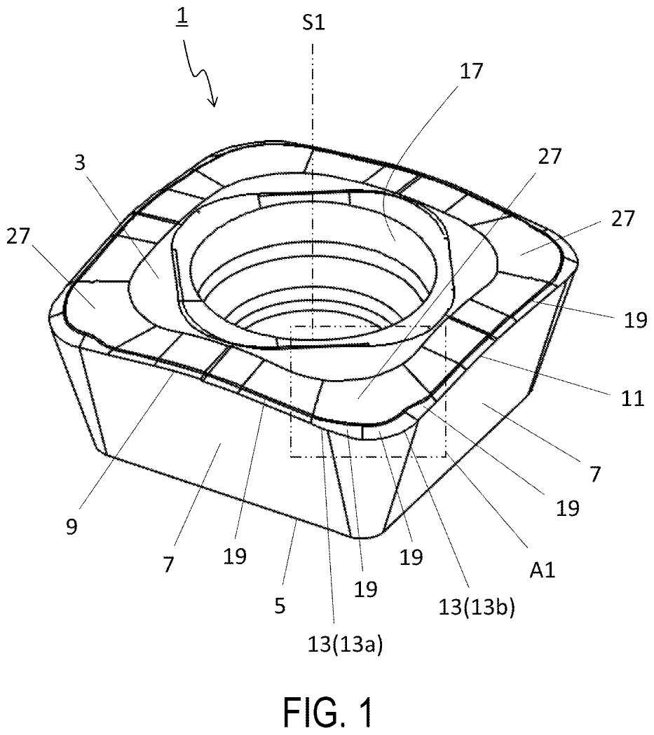

The insert 1 may be provided with a first face 3, a second face 5, a third face 7, a virtual central axis S1, and a virtual reference face S2. In a non-limited example illustrated in FIG. 1, the first face 3 may be a top face, the second face 5 may be a lower face, and the third face 7 may be a side face.

The first face 3 may include a first side 9, a second side 11, and a first corner 13. The first corner 13 may be positioned between the first side 9 and the second side 11. In other words, each of the first side 9 and the second side 11 may extend from the first corner 13. As illustrated in FIG. 1, the first face 3 may be a polygon including a plurality of corners and a plurality of sides. In the non-limited example illustrated in FIG. 1, one of the plurality of corners may be the first corner 13, and two of the plurality of sides may be respectively the first side 9 and the second side 11.

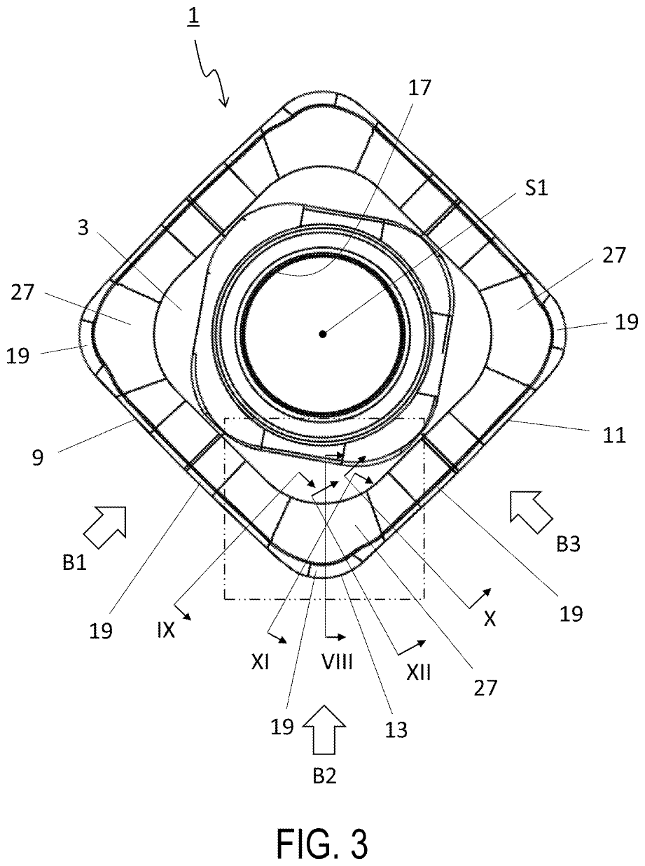

The first face 3 of the non-limited example illustrated in FIG. 1 may have a square shape. The shape of the first face 3 is not limited to the square shape. For example, the first face 3 may be triangular, pentagonal or hexagonal. The first face 3 of a non-limited example illustrated in FIG. 3 may have a roughly square shape, but the shape of the first face 3 is not limited to the roughly square shape. For example, the first side 3 may be rectangular or rhomboid.

The second face 5 may be positioned on a side opposite to the first face 3. The second face 5 of the non-limited example illustrated in FIG. 1 may have a polygonal shape including a plurality of corners and sides, similarly to the first face 3. Thus, the insert 1 illustrated in FIG. 1 may have a polygonal plate shape.

Note that the second face 5 may be polygonal in the same manner as the first face 3 but need not necessarily be the same size as the first face 3. For example, the second face 5 may be slightly smaller than the first face 3. Here, the polygonal shape does not strictly mean a shape of a polygon. For example, the four corners of the first face 3 need not necessarily each be a strict angle and may have a slightly rounded shape in a front view of the first face 3.

Also, the four sides need not necessarily be strictly linear in shape. In the non-limited example illustrated in FIG. 3, each of the four sides may include a curved portion that protrudes outward. Note that the curved portion of the side may be a gentle curve that has a larger radius of curvature than the corner of the first face 3.

The third face 7 may be positioned between the first face 3 and the second face 5. The third face 7 may be connected to the first face 3, or another face may be positioned between the first face 3 and the third face 7. Similarly, the third face 7 may be connected to the second face 5, or another face may be positioned between the second face 5 and the third face 7. In the non-limited example illustrated in FIG. 1, the third face 7 may be connected to the first face 3 and the second face 5.

A portion of the third face 7 connected to the first side 9 and a portion of the third face 7 connected to the second side 11 may each be flat surfaces. Further, the portion of the third face 7 connected to the first corner 13 may have a convex curved surface shape.

The central axis S1 may be a virtual straight line passing through the center of the first face 3 and the center of the second face 5. The center of the first face 3 can be identified by a center of gravity position of the first face 3 in a plan view, for example. The center of the second face 5 can be identified by a center of gravity position of the second face 5 in a plan view of the second face 5, for example.

The first face 3 and the second face 5 may be orthogonal to the central axis S1 or may be inclined with respect to the central axis S1. The first face 3 may have rotational symmetry with respect to the central axis S1. For example, as illustrated in FIG. 3, the first face 3 may have 90-degree rotational symmetry with respect to the central axis S1.

The reference plane S2 may be a virtual plane positioned between the first face 3 and the second face 5 and may be orthogonal to the central axis S1. The first face 3 and the second face 5 may be parallel to the reference plane S2 or may be inclined with respect to the reference plane S2. When a direction along the central axis S1 is used as a height, the reference plane S2 may be used as a reference of a position for evaluating the height of each of the portions configuring the first face 3.

The maximum width of the first face 3 in the front view may be from 6 mm to 25 mm, for example. Further, the height from the first face 3 to the second face 5 may be from 1 mm to 10 mm, for example. Here, the height from the first face 3 to the second face 5 may refer to a maximum value of a gap between the first face 3 and the second face 5 in the direction parallel to the central axis S1.

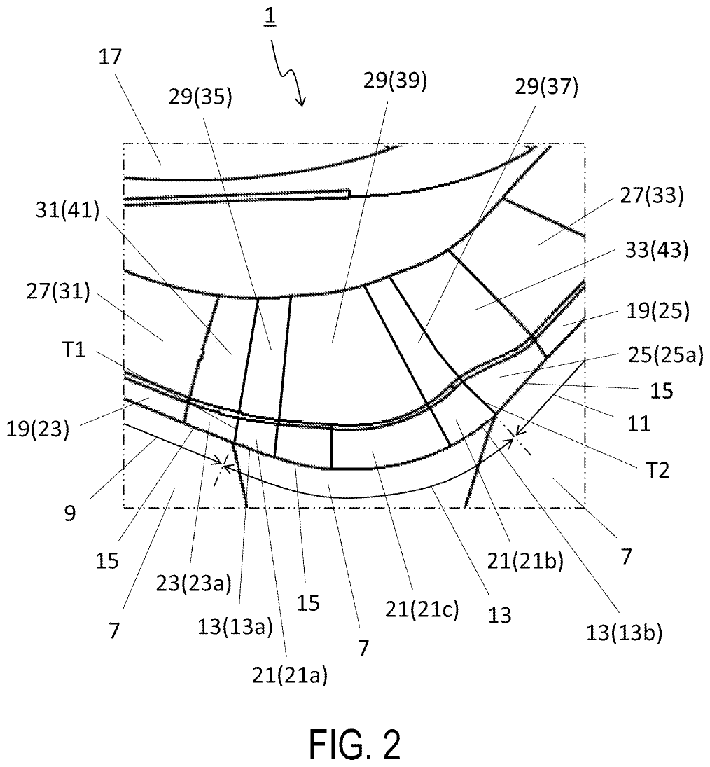

The insert 1 may include a cutting edge 15. The cutting edge 15 may be positioned to include at least a part of a ridge at which the first face 3 and the third face 7 meet. As illustrated in the non-limited example in FIG. 3, the cutting edge 15 may be positioned along all of the ridge at which the first face 3 and the third face 7 meet. Thus, in a non-limited example illustrated in FIG. 2, the cutting edge 15 may be positioned on at least the first corner 13, the first side 9, and the second side 11.

The insert 1 may include a through hole 17 that opens in the first face 3. For example, as illustrated in FIG. 1, the through hole 17 may be formed from the center of the first face 3 toward the center of the second face 5. The through hole 17 of the non-limited example also opens in the second face 5. The through hole 17 in the non-limited example illustrated in FIG. 1 may be formed from the center of the first face 3 toward the center of the second face 5. Therefore, in the non-limited example illustrated in FIG. 1, an axis of the through hole 17 may coincide with the central axis S1.

The through hole 17 can be used to insert a fixing member when fixing the insert 1 to a holder. A screw may be an example of the fixing member. When fixing the insert 1 to the holder, a clamping member may be used instead of the screw, for example. The through hole 17 may be formed from the center of the first face 3 toward the center of the second face 5, but the through hole 17 is not limited to such a configuration. For example, each of regions facing each other in the third face 7 may be open as each opening of the through hole 17.

The first face 3 may include a land face 19. The land face 19 may be a narrow band surface region positioned on a peripheral portion of the first face 3 and may be connected to the third face 7. The land face 19 may be used to increase the strength of the cutting edge 15 positioned on the ridge at which the first face 3 and the third face 7 meet. Thus, the land face 19 may be positioned to include the portion of the ridge described above that is used as the cutting edge 15. The width of the land face 19 may refer to a width in a direction orthogonal to the ridge described above in the front view.

The land face 19 may be inclined further away from the reference plane S2 as the further the land face 19 is away from the third face 7. In other words, in the non-limited example illustrated in FIG. 1, the height of the land face 19 from the reference face S2 may increase as the land face 19 is away from the third face 7. Therefore, the durability of the portion of the above-described ridge that is used as the cutting edge 15 may be high. An inclination angle of the land face 19 is not particularly limited. An inclination angle θ of the land face 19 can be set from 0° to 30°, for example.

The land face 19 in the non-limited example illustrated in FIG. 2 may include a first land face 21, a second land face 23, and a third land face 25. The first land face 21 may be a portion of the land face 19 connected to the first corner 13. The second land face 23 may be a portion of the land face 19 connected to the first side 9. The third land face 25 may be a portion of the land face 19 connected to the second side 11.

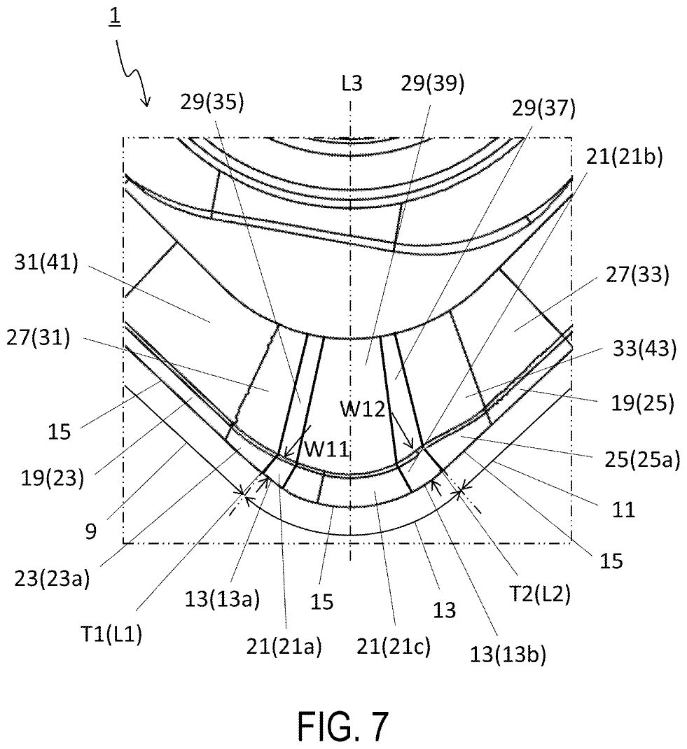

As illustrated in FIG. 7, a boundary between the first land face 21 and the second land face 23 (a first boundary T1) may be evaluated by extending, from a connection point between the first corner 13 and the first side 9, a virtual straight line L1 orthogonal to the outer periphery of the first face 3 at this connection point in the front view. As illustrated in FIG. 7, a boundary between the first land face 21 and the third land face 25 (a second boundary T2) may be evaluated by extending, from a connection point between the first corner 13 and the second side 11, a virtual straight line L2 orthogonal to the outer periphery of the first face 3 at this connection point in the front view.

The first land face 21 in the non-limited example illustrated in FIG. 7 may include a first region 21a and a second region 21b. The first region 21a may be a partial region of the first land face 21 and may be positioned in a location adjacent to the second land face 23. The first region 21a may be connected to the second land face 23 and may include the first boundary T1. The second region 21b may be a partial region of the first land face 21 and may be positioned in a location adjacent to the third land face 25. The second region 21b may be connected to the third land face 25 and may include the second boundary T2.

In the non-limited example illustrated in FIG. 7, a second width W12 of the second region 21b may be larger than a first width W11 of the first region 21a in the front view. The first width W11 may be a width of the first land face 21 in the first region 21a. The second width W12 may be a width of the first land face 21 in the second region 21b. Therefore, the durability of the insert 1 may be high during a case of machining in which, for example, the cutting edge angle of a portion of the first corner 13 positioned near the second side 11 (a second portion 13b) is larger than the cutting edge angle of a portion of the first corner 13 positioned near the first side 9 (a first portion 13a).

In a case where the cutting edge angle of the second portion 13b is larger than the cutting edge angle of the first portion 13a, a large cutting load may be more likely to be applied to the second region 21b than to the first region 21a. In the insert 1, the second width W12 of the first land face 21 in the second region 21b may be larger than the first width W11 of the first land face 21 in the first region 21a, and the durability of the portion to which the relatively large cutting load is likely to be applied may be high. Therefore, the durability of the insert 1 as a whole may be high.

Also, in the insert 1, a width W1 of the first land face 21 may not be large throughout a whole, and the second width W12 of the second region 21b may be relatively large, while the first width W11 of the first region 21a is relatively small. Therefore, it may be easy to avoid an excessive deterioration in cutting performance. As a result, for example, chatter vibration may be easily suppressed.

In this way, the insert 1 can achieve favorable machining both a case where the cutting edge angle of the second portion 13b is larger than the cutting edge angle of the first portion 13a, and a case where the first corner 13 is used as a flat cutting edge.

The first width W11 of the first region 21a and the width second W12 of the second region 21b are not limited to particular values. The first width W11 of the first region 21a can be set from 0.1 mm to 1 mm, for example. The second width W12 of the second region 21b can be set from 0.2 mm to 1.5 mm, for example. A ratio W12/W11 of the first width W11 of the first region 21a and the second width W12 of the second region 21b can be set from 1.1 to 3, for example.

A first inclination angle θ1 of the first region 21a with respect to the reference plane S2 may be the same as a second inclination angle θ2 of the second region 21b with respect to the reference plane S2. In this case, a change in the inclination angle of the first land face 21 may be small. As a result, variations in the strength of the insert 1 in the first land face 21 may be easily suppressed to be small. In addition, chips may tend to flow smoothly during machining.

The first land face 21 may include a third region 21c. The third region 21c in the non-limited example illustrated in FIG. 7 may be positioned on a bisector L3 of the first corner 13. Specifically, the third region 21c in the non-limited example illustrated in FIG. 7 may be positioned to include the bisector L3 of the first corner 13. The third region 21c may be positioned between the first region 21a and the second region 21b and may be positioned being sandwiched by the first region 21a and the second region 21b.

A third width W13 of the third region 21c may be larger than the first width W11 of the first region 21a and smaller than the second width W12 of the second region 21b in the front view. The third width W13 may be a width of the first land face 21 in the third region 21c. In a case where the width W1 of the first land face 21 changes in a stepwise manner as described above, the width W1 of the first land face 21 may be larger in the region where the cutting edge angle is larger. As a result, the durability of the insert 1 as a whole may be even higher while avoiding an excessive deterioration in the cutting performance.

The width W1 of the first land face 21 may increase from the first region 21a toward the second region 21b in the front view. In a case where the width W1 of the first land face 21 changes as described above, the width W1 of the first land face 21 may be larger in the region where the cutting edge angle is larger. As a result, the durability of the insert 1 as a whole may be even higher while avoiding an excessive deterioration in the cutting performance.

In a case where the first land face 21 includes the third region 21c, a third inclination angle θ3 of the third region 21c with respect to the reference face S2 may be the same as the first inclination angle θ1 of the first region 21a. In this case, a change in the inclination angle of the first land face 21 may be small. As a result, variations in the strength of the insert 1 in the first land face 21 may tend to be reduced and easily suppressed. In addition, the chips may tend to flow smoothly during machining.

The second land face 23 may include a fourth region 23a. The fourth region 23a in the non-limited example illustrated in FIG. 7 may be positioned extending from a location of the second land face 23 adjacent to the first land face 21 to the center of the first side 9. The fourth region 23a may extend from the first land face 21 to the center of the first side 9. Here, a fourth width W21 of the fourth region 23a may be constant in the front view. The fourth width W21 may be a width of the second land face 23 in the fourth region 23a.

For example, during a case of machining in which the cutting edge angle of the second portion 13b is larger than the cutting edge angle of the first portion 13a, the large cutting load may be more likely to be applied to the cutting edge 15 positioned on the first corner 13 than to the cutting edge 15 positioned on the first side 9. As such, a relatively large cutting load may be likely to be applied to the fourth region 23a, which is the portion of the second land face 23 positioned near the first land face 21, in comparison to other portions of the second land face 23.

In a case where the fourth width W21 of the fourth region 23a positioned relatively close to the first land face 21 is constant, the load may be easily distributed over a wide range of the second land face 23. Therefore, the durability of the second land face 23 may be high.

The third land face 25 may include a fifth region 25a. The fifth region 25a in the non-limited example illustrated in FIG. 7 may be positioned in a location, in the third land face 25, adjacent to the first land face 21. The fifth region 25a may be connected to the first land face 21. Here, a fifth width W31 of the fifth region 25a may decrease as the third land face 25 is away from the first land face 21 in the front view. The fifth width W31 may be a width of the third land face 25 in the fifth region 25a.

For example, if the first corner 13 is used as the flat cutting edge, surface roughness may be small and surface accuracy of the machined surface may be high. If a portion of the first side 9 connected to the fifth region 25a is used as part of the flat cutting edge, cutting resistance of the above-described portion on the first side 9 may be suppressed to be small.

The first face 3 may include a rake face 27. The rake face 27 in the non-limited example illustrated in FIG. 7 may be positioned inward from the land face 19. The rake face 27 may be inclined further away from the reference plane S2 as the rake face 27 is away from the land face 19. In a case where the first face 3 includes the rake face 27, a flow direction of the chips generated at the cutting edge 15 may be easily controlled. As a result, the chips can be processed in a stable manner.

The rake face 27 may include a first rake face 29, a second rake face 31, and a third rake face 33. In the non-limited example illustrated in FIG. 7, the first rake face 29 may be a region of the rake face 27 connected to the first land face 21. The second rake face 31 may be a region of the rake face 27 connected to the second land face 23. The third rake face 33 may be a region of the rake face 27 connected to the third land face 25.

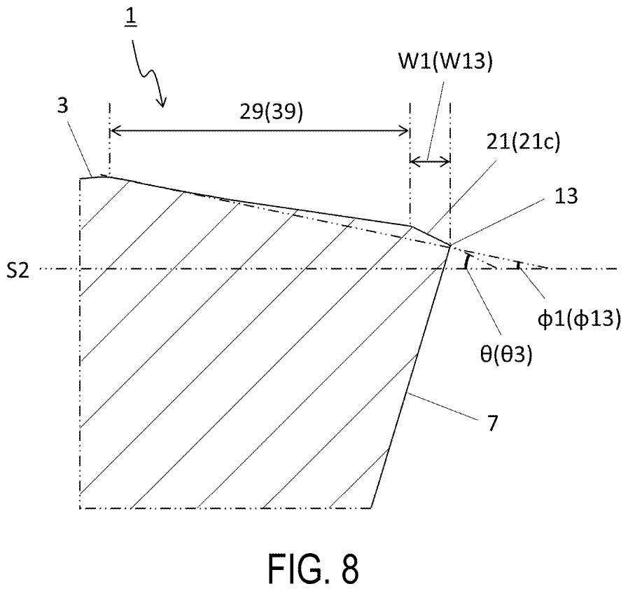

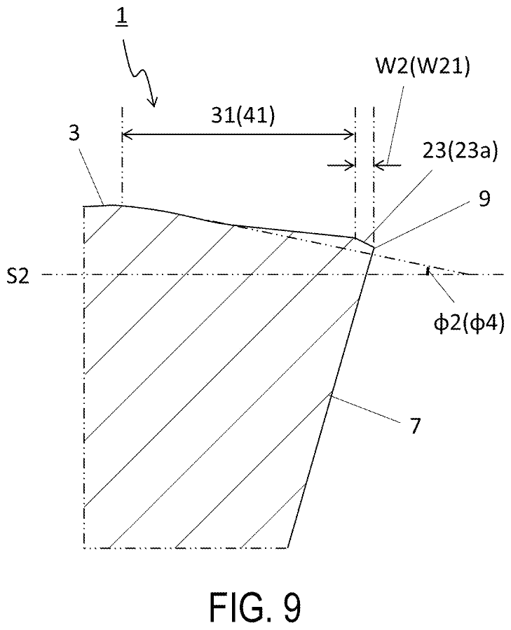

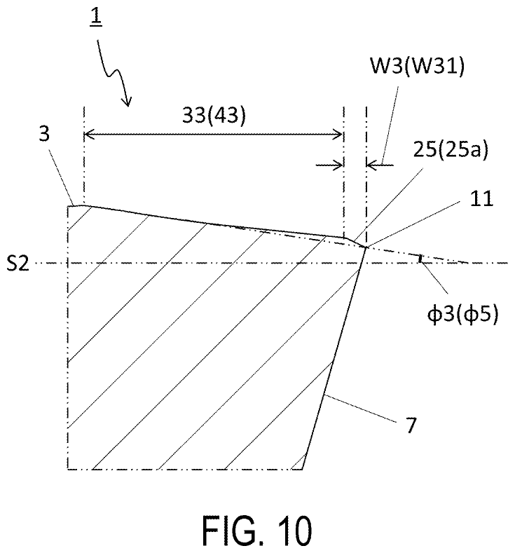

As illustrated in FIG. 8, a maximum value of an inclination angle of the first rake face 29 with respect to the reference face S2 may be φ1. As illustrated in FIG. 9, a maximum value of an inclination angle of the second rake face 31 with respect to the reference plane S2 may be φ2. As illustrated in FIG. 10, a maximum value of an inclination angle of the third rake face 33 with respect to the reference face S2 may be φ3. At this time, the inclination angle φ1 may be larger than the inclination angle φ2 and the inclination angle φ3.

During the machining of the workpiece, the flow direction of chips generated at the first corner 13 may be more likely to be unstable than that of the chips generated at the first side 9 and the second side 11. However, if the inclination angle φ1 is larger than the inclination angle φ2 and the inclination angle φ3, the flow direction of the chips generated at the first corner 13 may be easily controlled at the first rake face 29. As a result, the chips may be easily processed in a stable manner.

The first rake face 29 may include a first section 35, a second section 37, and a third section 39. In the non-limited example illustrated in FIG. 7, the first section 35 may be a region of the first rake face 29 positioned in a location adjacent to the second rake face 31. The first section 35 may be connected to the second rake face 31. The second section 37 may be a region of the first rake face 29 positioned in a location adjacent to the third rake face 33. The second section 37 may be connected to the third rake face 33.

The third section 39 may be a region positioned on the bisector L3 of the first corner 13. Specifically, the third section 39 in the non-limited example illustrated in FIG. 7 may be positioned to include the bisector L3 of the first corner 13 in the front view. The third section 39 may be positioned between the first section 35 and the second section 37 and may be positioned being sandwiched by the first section 35 and the second section 37.

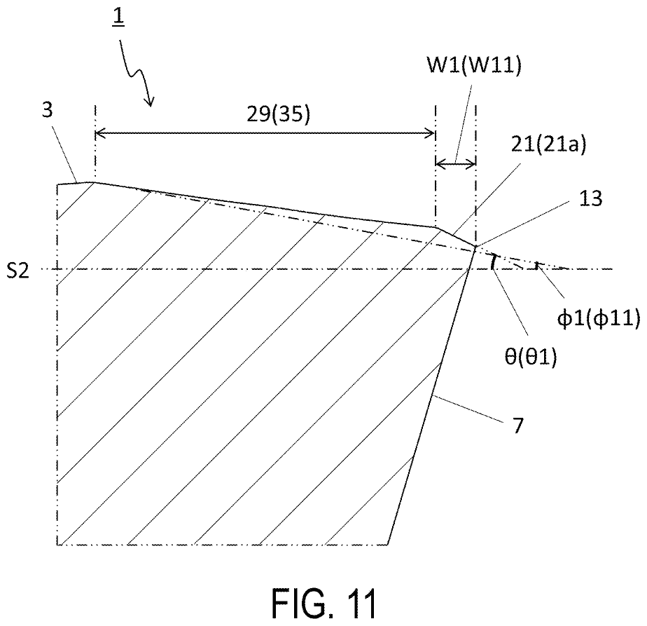

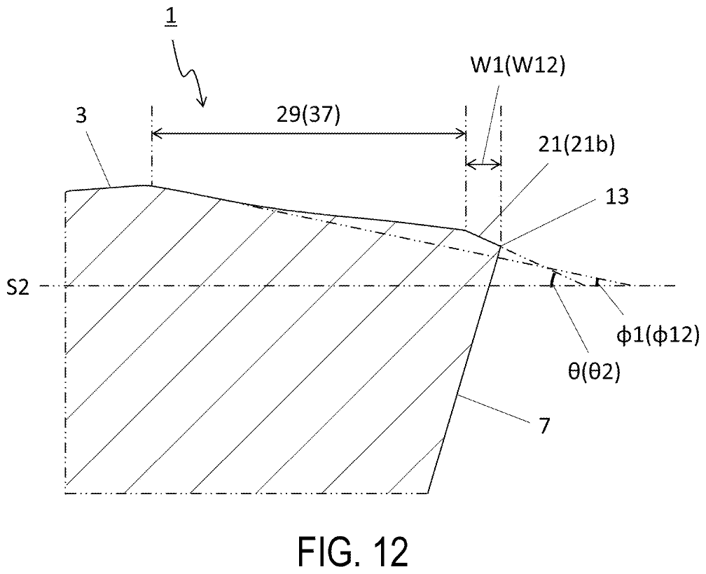

As illustrated in FIG. 11, an inclination angle of the first section 35 with respect to the reference face S2 may be φ11. As illustrated in FIG. 12, an inclination angle of the second section 37 with respect to the reference face S2 may be φ12. As illustrated in FIG. 8, an inclination angle of the third section 39 with respect to the reference face S2 may be (p13. At this time, the inclination angle φ13 may be larger than the inclination angle φ11 and the inclination angle φ12.

During the machining of the workpiece, the flow direction of the chips generated at the first corner 13 may be more likely to be unstable than that of the chips generated at the first side 9 and the second side 11. In particular, the flow direction of the chips generated at the center of the first corner 13 positioned on the bisector L3 of the first corner 13 may easily become unstable. However, if the inclination angle φ13 is larger than the inclination angle φ11 and the inclination angle φ12, the direction of flow of the chips generated at the center of the first corner 13 may be easily controlled in the third section 39. As a result, the chips may be easily processed in a stable manner.

The second rake face 31 may include a fourth section 41. The fourth section 41 in the non-limited example illustrated in FIG. 7 may be positioned in a location adjacent to the first rake face 29. The fourth section 41 may be connected to the first rake face 29. In a case where an inclination angle of the fourth section 41 with respect to the reference face S2 is φ4, the inclination angle φ4 may decrease as the fourth section 41 is away from the first rake face 29.

During the machining of the workpiece, the flow direction of the chips generated at the first side 9 may be more likely to be stable than that of the chips generated at the first corner 13. In a case where the inclination angle φ4 decrease as the fourth section 41 is away from the first rake face 29, the inclination angle φ2 may be easily made smaller while avoiding abrupt changes in the inclination angle φ1 and the inclination angle φ2. As a result, the flow of chips generated at the first side 9 may tend to be smooth.

The third rake face 33 may include a fifth section 43. The fifth section 43 in the non-limited example illustrated in FIG. 7 may be positioned in a location adjacent to the first rake face 29. The fifth section 43 may be connected to the first rake face 29. In a case where an inclination angle of the fifth section 43 with respect to the reference face S2 is φ5, the inclination angle φ5 may decrease as the fifth section 43 is away from the first rake face 29.

During the machining of the workpiece, the flow direction of the chips generated at the second side 11 may be more likely to be stable than that of the chips generated at the first corner 13. In a case where the inclination angle φ5 decrease as the fifth section 43 is away from the first rake face 29, the inclination angle φ3 may be easily made smaller while avoiding abrupt changes in the inclination angle φ1 and the inclination angle φ3. As a result, the flow of the chips generated at the second side 11 may tend to be smooth.

Examples of a material of the insert 1 may include cemented carbide alloy and cermet. Examples of the composition of the cemented carbide alloy may include WC—Co, WC—TiC—Co, and WC—TiC—TaC—Co. Here, WC, TiC, and TaC may be hard particles, and Co may be a binder phase.

In addition, the cermet may be a sintered composite material obtained by combining a metal with a ceramic component. Specifically, examples of the cermet may include titanium compounds in which one of titanium carbide (TiC) and titanium nitride (TiN) is the main component. However, it goes without saying that the material of the insert 1 is not limited to the composition described above.

The surface of the insert 1 may be coated with a coating film using a chemical vapor deposition (CVD) method or a physical vapor deposition (PVD) method. Examples of the composition of the coating film include titanium carbide (TiC), titanium nitride (TiN), titanium carbonitride (TiCN), alumina (Al₂O₃), and the like.

### Cutting Tool

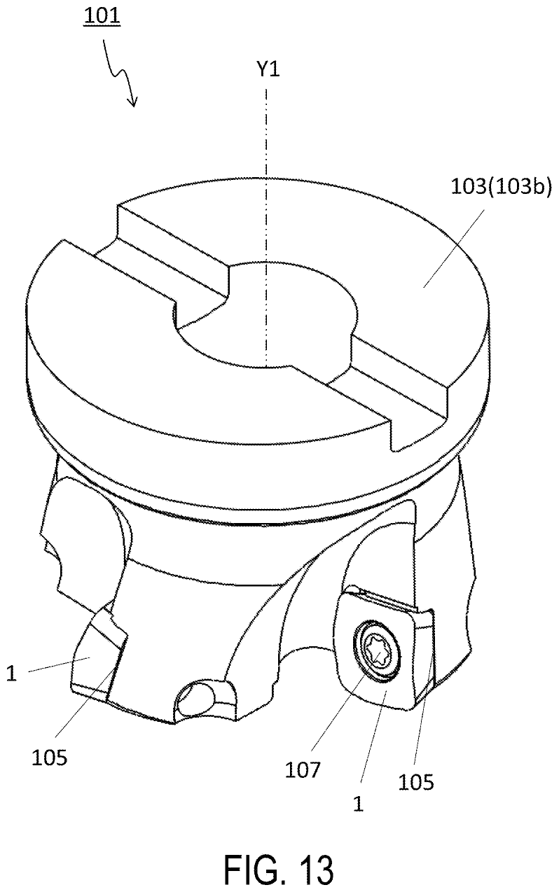

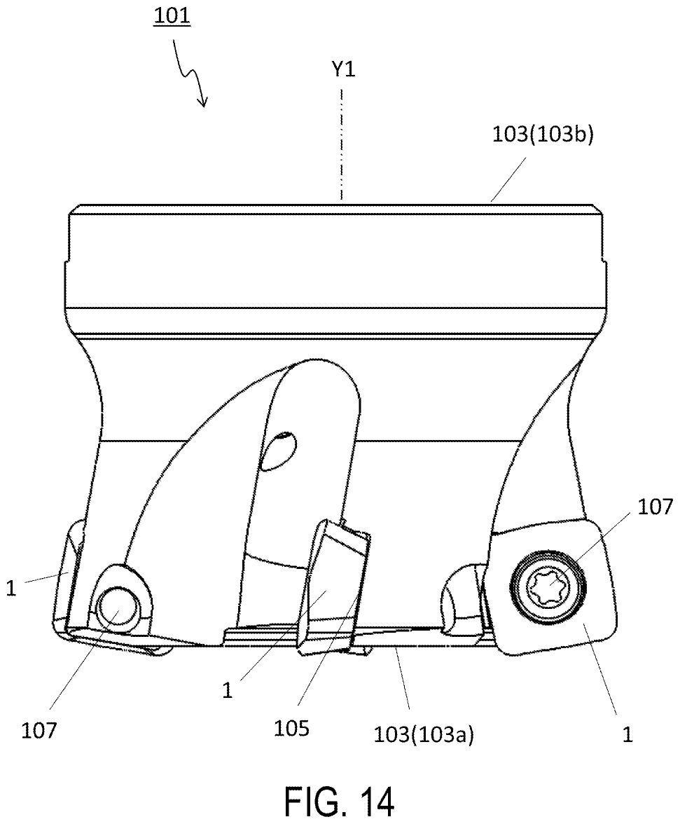

Next, a cutting tool 101 of a non-limiting embodiment will be described using FIG. 13 and FIG. 14. FIG. 13 and FIG. 14 may illustrate a state in which the insert 1 illustrated in FIG. 1 is attached to a pocket 105 of a holder 103 using a screw 107. Note that in FIG. 13 and the like, a rotation axis Y1 of the cutting tool 101 may be indicated by a two-dot chain line.

The cutting tool 101 may be used for milling processing. The cutting tool 101 may be provided with the holder 103 and the insert 1, as illustrated in FIG. 13. The holder 103 may have a cylindrical shape extending from a first end 103a to a second end 103b along the rotation axis Y1. Further, the holder 103 may include the pocket 105 positioned a side of the first end 103a. The pocket 105 may include the first end 103a or may be away from the first end 103a. The insert 1 may be positioned in the above-described pocket 105.

There may be only one of the pockets 105, or as in a non-limited example illustrated in FIG. 13, a plurality of the pockets 105 may be provided. In a case where the holder 103 includes the plurality of pockets 105, the cutting tool 101 may include a plurality of the inserts 1, with one of the inserts 1 being positioned in each of the pockets 105.

The pocket 105 may be open to an outer circumferential face of the holder 103 and an end face nearer on the first end 103a. In a case where the holder 103 includes the plurality of pockets 105, these pockets 105 may be positioned at equal intervals or may be positioned at unequal intervals about the rotation axis Y1. As is clear from the fact that the holder 103 includes the pocket 105 and the like, the holder 103 does not have a strictly cylindrical shape.

The insert 1 may be mounted in the pocket 105 such that at least a part of the cutting edge 15 protrudes from the holder 103. Specifically, the insert 1 may be mounted on the holder 103 such that the cutting edge is positioned further to the outside than the outer peripheral surface of the holder 103.

In the cutting tool 101, the second face 5 and the third face 7 of the insert 1 abut the holder 103.

The insert 1 may be mounted in the pocket 105 using the screw 107. Specifically, the screw 107 may be inserted into the through hole 17 in the insert 1, the leading end of the screw 107 may be inserted into a screw hole formed in the pocket 105, and the insert 1 may be mounted on the holder 103 by fixing the screw 107 into the screw hole.

Steel, cast iron, or the like can be used as the holder 103. Among these materials, steel may be used in particular, from the viewpoint of increasing toughness of the holder 103.

### Method for Manufacturing Machined Product

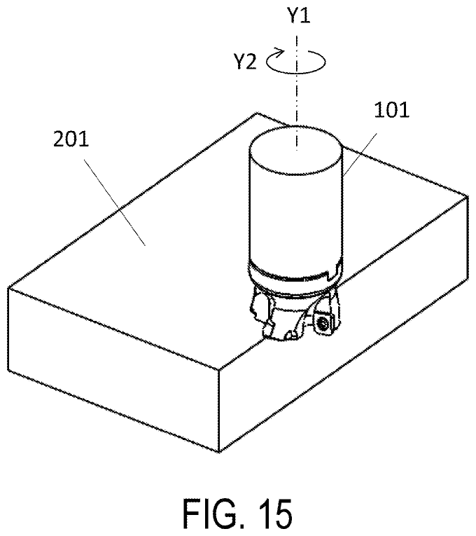

Next, a description will be given of a method for manufacturing a machined product according to a non-limiting embodiments with reference to FIG. 15 to FIG. 17. FIG. 15 to FIG. 17 may illustrate a method for manufacturing a machined product when machining is performed using the cutting tool described above. In FIG. 15 to FIG. 17, the rotation axis Y1 of the cutting tool 101 may be indicated by a two-dot chain line. A machined product 203 may be manufactured by machining a workpiece 201. The method for manufacturing the machined product may include the following steps. Specifically, the steps may include:

(1) rotating the cutting tool 101;

(2) bringing the cutting tool 101 that is rotating into contact with the workpiece 201; and

(3) separating the cutting tool 101 from the workpiece 201.

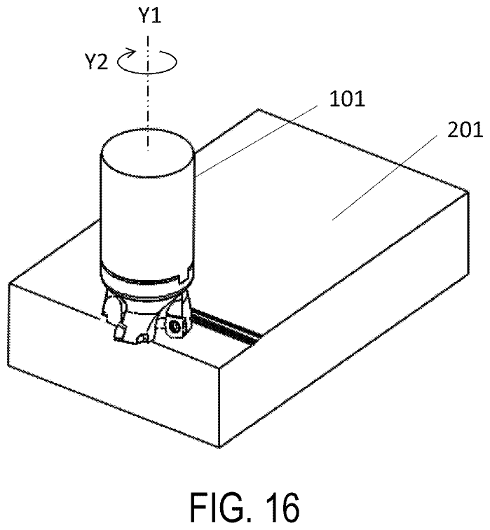

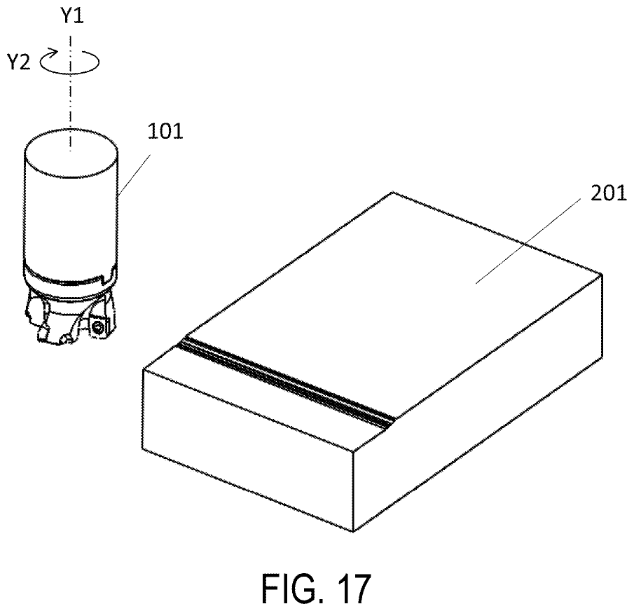

More specifically, first, as illustrated in FIG. 15, the cutting tool 101 may be brought relatively close to the workpiece 201 while being rotated in a direction Y2 around the rotation axis Y1. Next, as illustrated in FIG. 16, the cutting edge of the cutting tool 101 may be brought into contact with the workpiece 201 and may cut the workpiece 201. Then, as illustrated in FIG. 17, the cutting tool 101 may be relatively moved away from the workpiece 201.

The workpiece 201 may be fixed and the cutting tool 101 may be brought close to the workpiece 201. In addition, in FIG. 15 to FIG. 17, the workpiece 201 may be fixed and the cutting tool 101 may be rotated around the rotation axis Y1. Further, in FIG. 17, the workpiece 201 may be fixed and the cutting tool 101 may be moved away from the workpiece 201. Here, in the machining in the manufacturing method, in each of these steps, the workpiece 201 may be fixed and the cutting tool 101 may be moved, but the manufacturing method is of course not limited thereto.

For example, in step (1), the work piece 201 may be brought close to the cutting tool 101. In the same manner, in step (3), the work piece 201 may be moved away from the cutting tool 101. In a case in which the machining is to be continued, steps of bringing the cutting edge 15 of the insert 1 into contact with different locations on the workpiece 201 may be repeated while maintaining the rotating state of the cutting tool 101.

Here, representative examples of the material of the workpiece 201 may include carbon steel, alloy steel, stainless steel, cast iron, non-ferrous metals, and the like.

### REFERENCE SIGNS LIST

1 Cutting insert (insert)
3 First face
5 Second face
7 Third face
9 First side
11 Second side
13 First corner
13a First portion
13b Second portion
15 Cutting edge
17 Through hole
19 Land face
21 First land face
21a First region
21b Second region
21c Third region
23 Second land face
23a Fourth region
25 Third land face
25a Fifth region
27 Rake face
29 First rake face
31 Second rake face
33 Third rake face
35 First section
37 Second section
39 Third section
41 Fourth section
43 Fifth section
101 Cutting tool
103 Holder
103a First end
103b Second end
105 Pocket
107 Screw
201 Workpiece
S1 Central axis
S2 Reference face
θ Inclination angle of land face
θ1 First inclination angle
θ2 Second inclination angle
θ3 Third inclination angle
T1 First boundary
T2 Second boundary
L1 Virtual straight line (line from T1)
L2 Virtual straight line (line from T2)
L3 Bisector
W1 Width of first land face
W11 First width
W12 Second width
W13 Third width
W2 Width of second land face
W21 Fourth width
W3 Width of third land face
W31 Fifth width
φ1 Inclination angle of first rake face
φ2 Inclination angle of second rake face
φ3 Inclination angle of third rake face
φ11 Inclination angle of first section
φ12 Inclination angle of second section
φ13 Inclination angle of third section
φ4 Inclination angle of fourth section
φ5 Inclination angle of fifth section

1. A cutting insert comprising:
a first face comprising a first side, a second side, and a first corner positioned between the first side and the second side;
a second face positioned on an opposite side to the first face;
a third face positioned between the first face and the second face;
a virtual central axis passing through a center of the first face and a center of the second face; and
a virtual reference plane that is positioned between the first face and the second face and is orthogonal to the central axis, wherein
the first face comprises a land face that is connected to the third face and is inclined further away from the reference plane as the land face is away from the third face,
the land face comprises
a first land face connected to the first corner,
a second land face connected to the first side, and
a third land face connected to the second side,
the first land face comprises
a first region connected to the second land face, and
a second region connected to the third land face, and
a second width of the second region is larger than a first width of the first region in a front view of the first face.

2. The cutting insert according to claim 1, wherein
a first inclination angle of the first region with respect to the reference plane is the same as a second inclination angle of the second region with respect to the reference plane.

3. The cutting insert according to claim 1, wherein
the first land face further comprises a third region positioned on a bisector of the first corner, and
a third width of the third region is larger than the first width of the first region, and is smaller than the second width of the second region in the front view.

4. The cutting insert according to claim 3, wherein
a width of the first land face increases from the first region toward the second region in the front view.

5. The cutting insert according to claim 3, wherein
a third inclination angle of the third region with respect to the reference plane is the same as the first inclination angle of the first region.

6. The cutting insert according to claim 1, wherein
the second land face comprises a fourth region extending from the first land face to a center of the first side, and
a fourth width of the fourth region is constant in the front view.

7. The cutting insert according to claim 1, wherein
the third land face comprises a fifth region connected to the first land face, and
a fifth width of the fifth region decreases as the third land face is away from the first land face in the front view.

8. The cutting insert according to claim 1, wherein
the first face comprises a rake face that is positioned inward from the land face and is inclined further away from the reference plane as the rake face is away from the land face,
the rake face comprises
a first rake face connected to the first land face,
a second rake face connected to the second land face, and
a third rake face connected to the third land face, and
a maximum value of an inclination angle of the first rake face with respect to the reference plane is larger than a maximum value of an inclination angle of the second rake face with respect to the reference plane.

9. The cutting insert according to claim 8, wherein
the first rake face comprises
a first section connected to the second rake face,
a second section connected to the third rake face, and
a third section positioned on the bisector of the first corner, and
an inclination angle of the third section with respect to the reference plane is larger than an inclination angle of the first section with respect to the reference plane and an inclination angle of the second section with respect to the reference plane.

10. The cutting insert according to claim 9, wherein
the second rake face comprises a fourth section connected to the first rake face, and
an inclination angle of the fourth section with respect to the reference plane decreases as the fourth section is away from the first rake face.

11. The cutting insert according to claim 9, wherein
the third rake face comprises a fifth section connected to the first rake face, and an inclination angle of the fifth section with respect to the reference plane decreases as the fifth section is away from the first rake face.

12. A cutting tool comprising:
a holder having a rod shape extending from a first end to a second end, and comprising a pocket positioned a side of the first end; and
the cutting insert according to claim 1 positioned in the pocket.

13. A method for manufacturing a machined product, comprising:
rotating the cutting tool according to claim 12;
bringing the cutting tool that is rotating into contact with a workpiece; and
separating the cutting tool from the workpiece.
